(19) United States
(12) Patent Application Publication
(10) Pub. No.: US 2016/0244226 A1
(43) Pub. Date: Aug. 25, 2016

(54) POWDERED DISPENSER CONTAINER WITH A COMBINED SCOOP HOLDER AND SCRAPER

(71) Applicant: MUNCHKIN, INC., Van Nuys, CA (US)

(72) Inventors: Steven Bryan Dunn, Beverly Hills, CA (US); Quinn Michael BIESINGER, Los Angeles, CA (US); Mark A. HATHERILL, Beverly Hills, CA (US); Thomas BIRKERT, West Hills, CA (US)

(21) Appl. No.: 15/054,002

(22) Filed: Feb. 25, 2016

Related U.S. Application Data
(60) Provisional application No. 62/120,813, filed on Feb. 25, 2015.

(51) Int. Cl. B65D 51/24; G01F 19/00

(52) U.S. Cl. CPC B65D 51/246; G01F 19/002

(57) ABSTRACT

A container assembly for storing and dispensing flowable products. The container assembly having a container, a collar, a lid and a ledge. The container has a closed lower end and an upper open end defining an internal opening therein. The collar is connected to the upper open end of the container. The lid is connected to the collar and has a holder mechanism comprising a pair of projections defining a slotted opening into which a handle of a scoop is removably secured. The ledge extends partially into the internal opening and has a flat portion adapted to scrape off excess material scooped from within the container.

### CROSS REFERENCE TO RELATED APPLICATION

The application claims priority to U.S. Provisional Patent Application Ser. No. 62/120,813, filed Feb. 25, 2015, the contents of which are hereby incorporated by reference herein in its entirety into this disclosure.

### TECHNICAL FIELD

The subject disclosure relates to a container for storing and dispensing flowable products.

### BACKGROUND

Infant formula and various other granulated or powder products are packaged in containers. Conveniently locating a scoop within these containers has oftentimes been a difficult task because the scoop so often becomes buried in the flowable material. Sifting through the flowable material frequently introduces various types of bacteria or the like from the user's hand. Likewise, rummaging through the container looking for the scoop can cause spillage of the material from within the container. While some of the material may fall back into the interior of the container, much of it may be wasted and contaminated as it spills onto the surrounding areas.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 is an upper front perspective view of a container according to the subject disclosure.

FIG. 2 is an upper front perspective view of the container with a lid open and the seal disposed.

FIG. 3 is the upper front perspective view of the container with the lid removed and the seal removed.

FIG. 4 is the upper front perspective view of the container with the lid and seal removed and measuring device secured to the ledge.

FIG. 5 is a front view of the container.

FIG. 6 is a rear view of the container.

FIG. 7 is a right side view thereof, the left side view being a mirror image thereof.

FIG. 8 is side view of the container with the lid opened.

FIG. 9 is a side view of the container with the measuring device attached to the lid.

FIG. 10 is a top view of the container.

FIG. 11 is a top view of the container with the lid open showing the scraper.

FIG. 12 is a top view of the container with the lid open showing the scraper and measuring device holder assembly.

FIG. 13 is a bottom view of the container.

FIG. 14 is an upper perspective view of the container with the lid open showing another embodiment for the ledge and scraper.

FIG. 15 is an upper perspective view of the container with the lid open showing the measuring device secured within the cut-out portion of the ledge.

FIG. 16 is a top view of the container with the lid open showing the cut-out portion in the ledge adapted to securely receive the measuring device.

FIGS. 17-19 show various views of an exemplary measuring device.

FIG. 20 depicts various views of the measuring device according to the subject disclosure.

### DETAILED DESCRIPTION

Particular embodiments of the present invention will now be described in greater detail with reference to the figures.

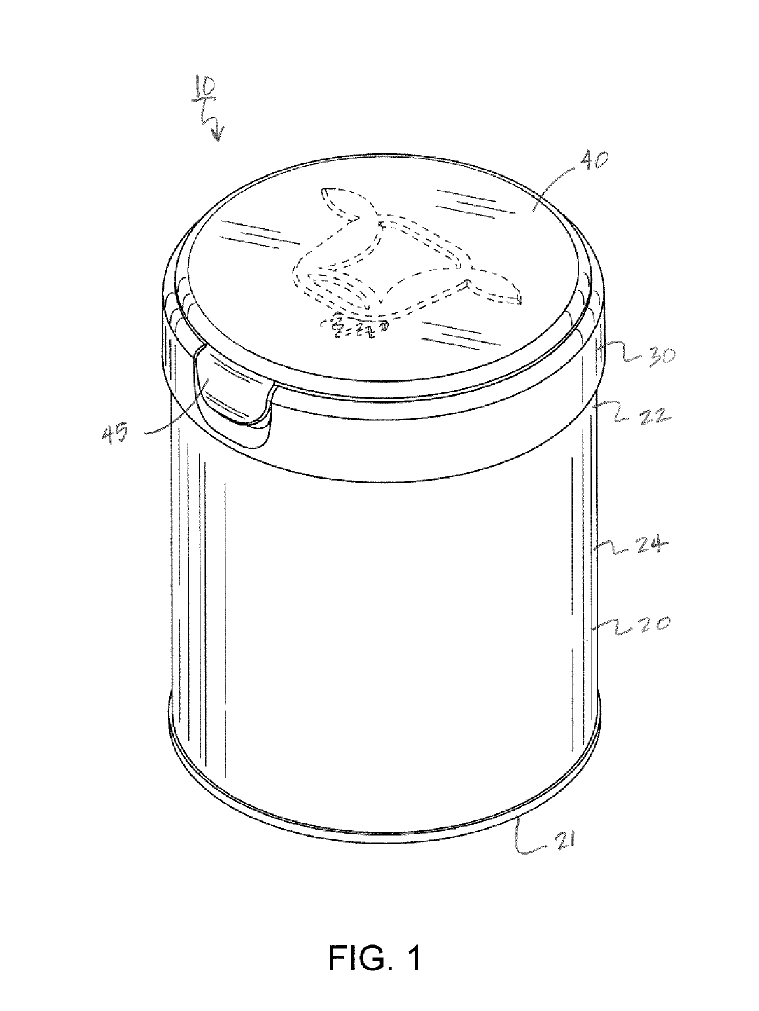

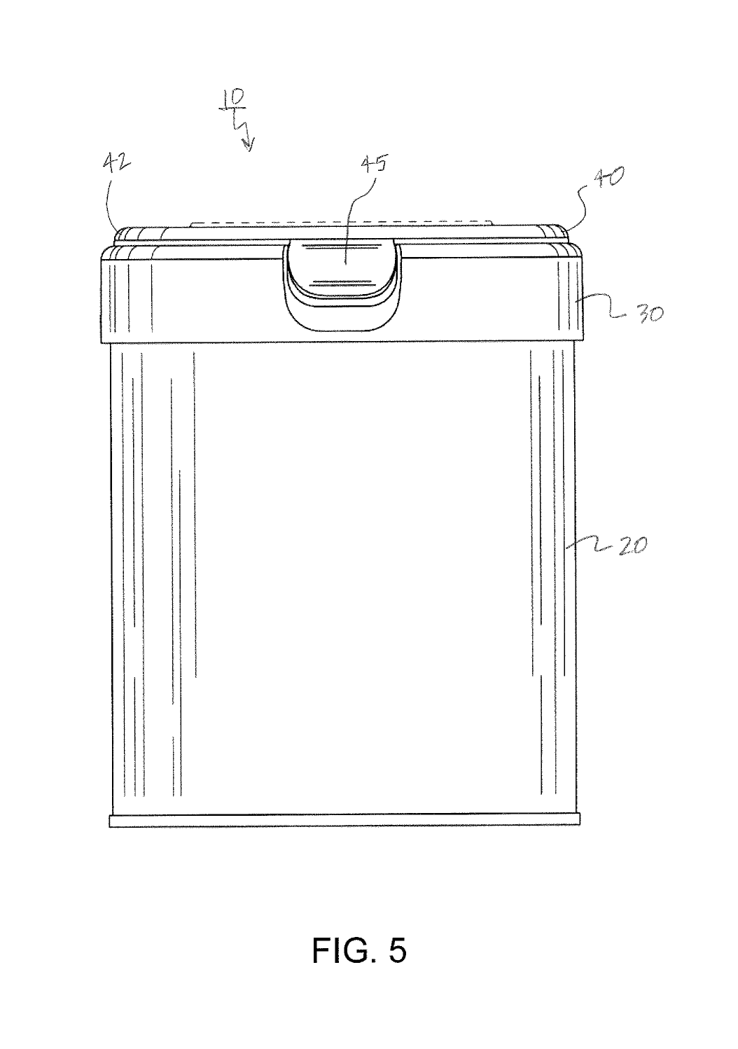

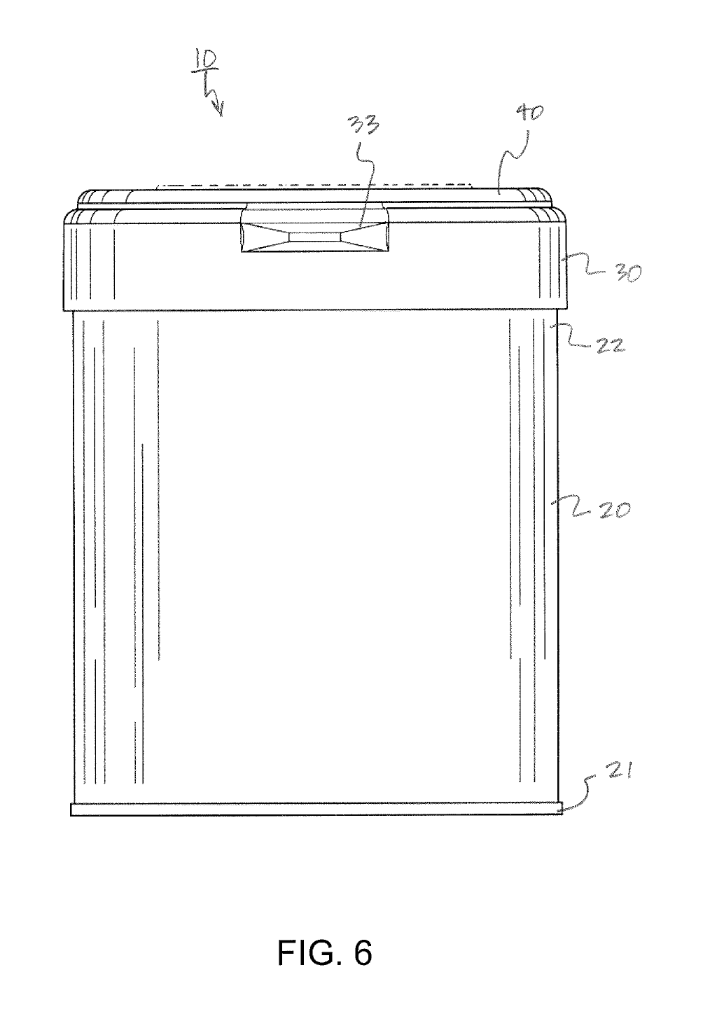

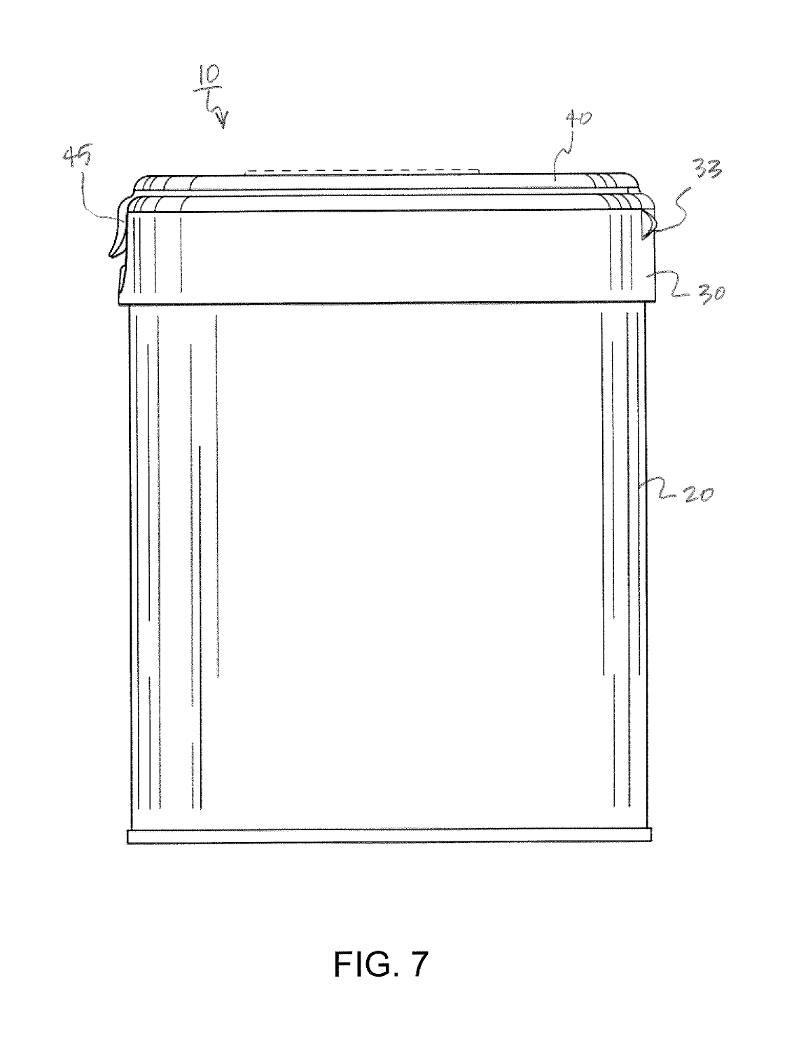

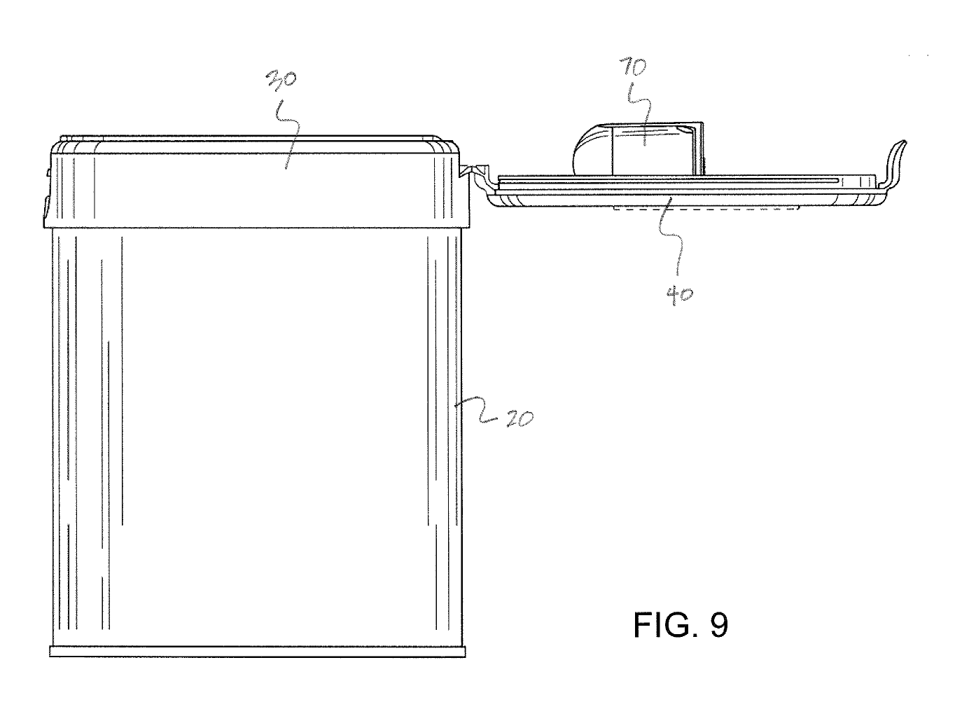

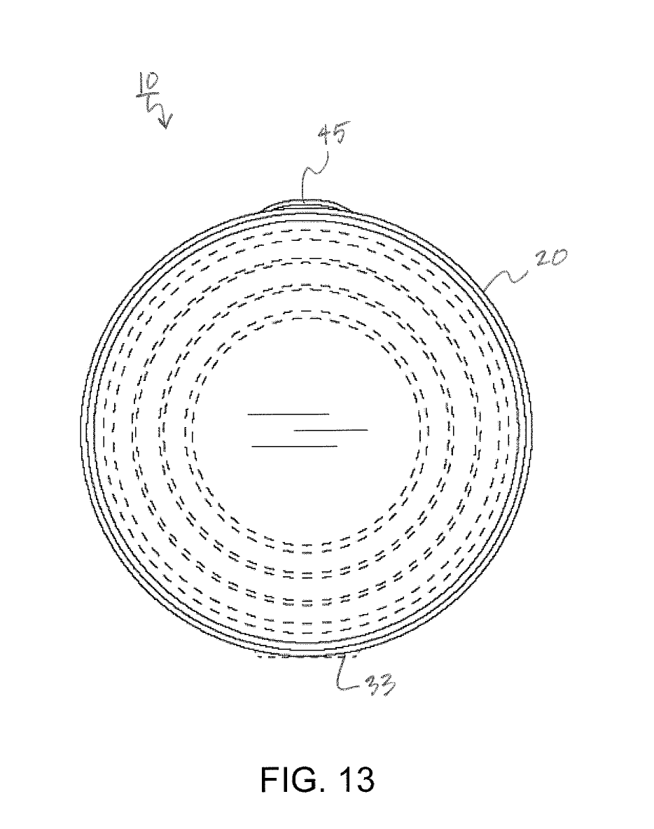

FIGS. 1-20 illustrate various views of the container assembly 10 according to this subject disclosure. The container assembly 10 is suitable to hold various types of flowable contents, such as a powdered or granular infant formula

As shown in FIGS. 1-4, the container assembly 10 includes a container 20, a collar 30 and a lid 40. Within the construction of the container assembly 10 is provided a ledge 50 and a seal 60 adapted to secure the flowable contents within the container 20. A measuring device 70 is also provided for use with the container assembly 10.

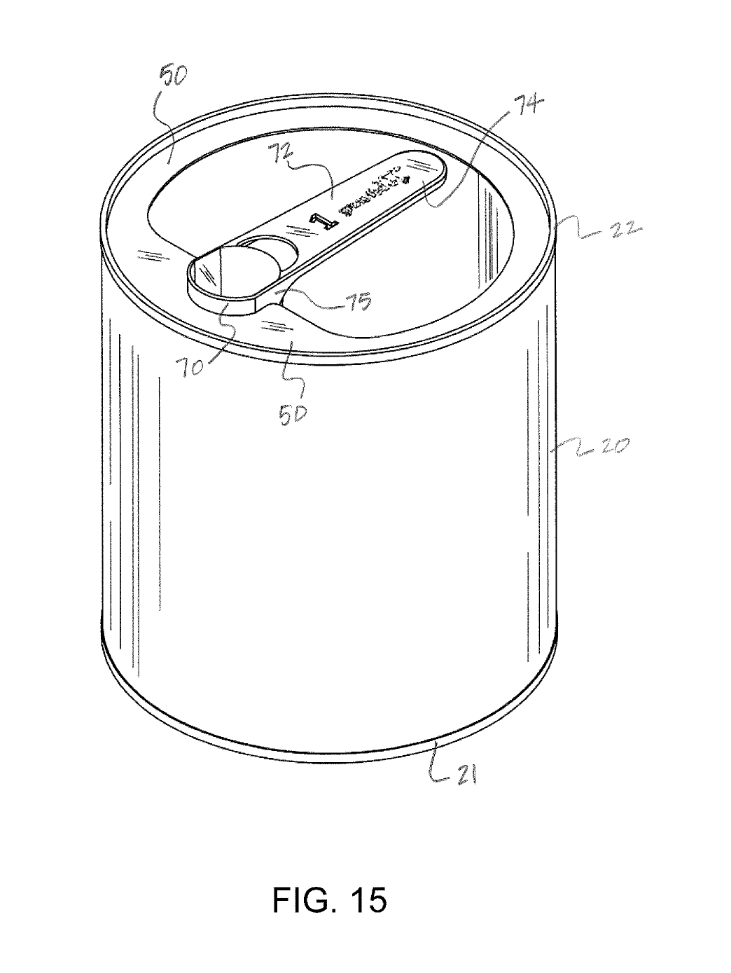

As shown in FIG. 15, the container 20 has a lower closed end 21 and an upper open end 22 defining an internal opening 23 therein. Those skilled in the art will readily understand that the container 20 may take a variety of different shapes.

According to this subject disclosure, the container 20 has a cylindrical body, providing a circular cross-section. Likewise, the collar 30 and the lid 40 are of similar circular construction. An internal opening 23 or cavity is disposed within the container 20 and is adapted to hold the flowable material, such as a granulated infant powder, or the like. An outer casing 24 of the container 20 may be constructed of a suitable metal or plastic material of approximately uniform wall thickness.

The container 20 may be composed of various materials suitable to hold a granulated flowable material. Various examples include, but are not limited to, being constructed of a metal material, tin, metal plated tin, aluminum or other metal or alloy. Alternatively, the container 20 may be constructed of a suitable plastic material that is recyclable or non-recyclable, such as for example, but not limited to, polystyrene, polystyrene-acrylonitile, acrylonitile-butadiene-styrene, styrene-maleic anhydride, polycarbonate, high density polyethylene, polyethylene copolymers, polypropylene, polypropylene copolymers, polyethylene terephthalate, polyvinylcyclohexane, and the like.

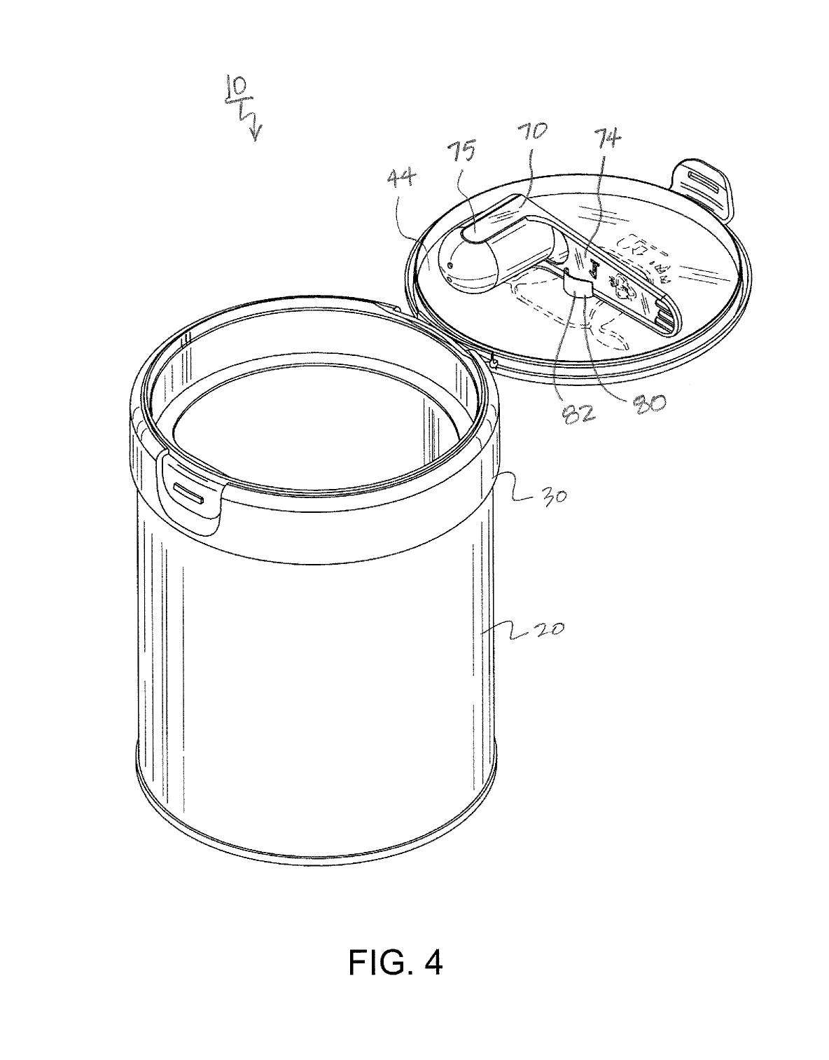

As shown in FIGS. 4-7, the collar 30 is connected to the upper open end 22 of the container 20. The collar 30 is shaped to be snugly secured to the upper open end 22 of the container 20. The collar 30 is cylindrical in shape and has a slightly elongated wall giving height to the overall height of the container assembly 10 to house various items, such as a measuring device 70 therein. That is, this additional height is advantageous, such as during initial assembly in which the measuring device 70 can be stored in the spaced defined between the height of the collar 30 and the removable seal 60. One of ordinary skill in the art could vary the size and shape of the collar according to the subject disclosure.

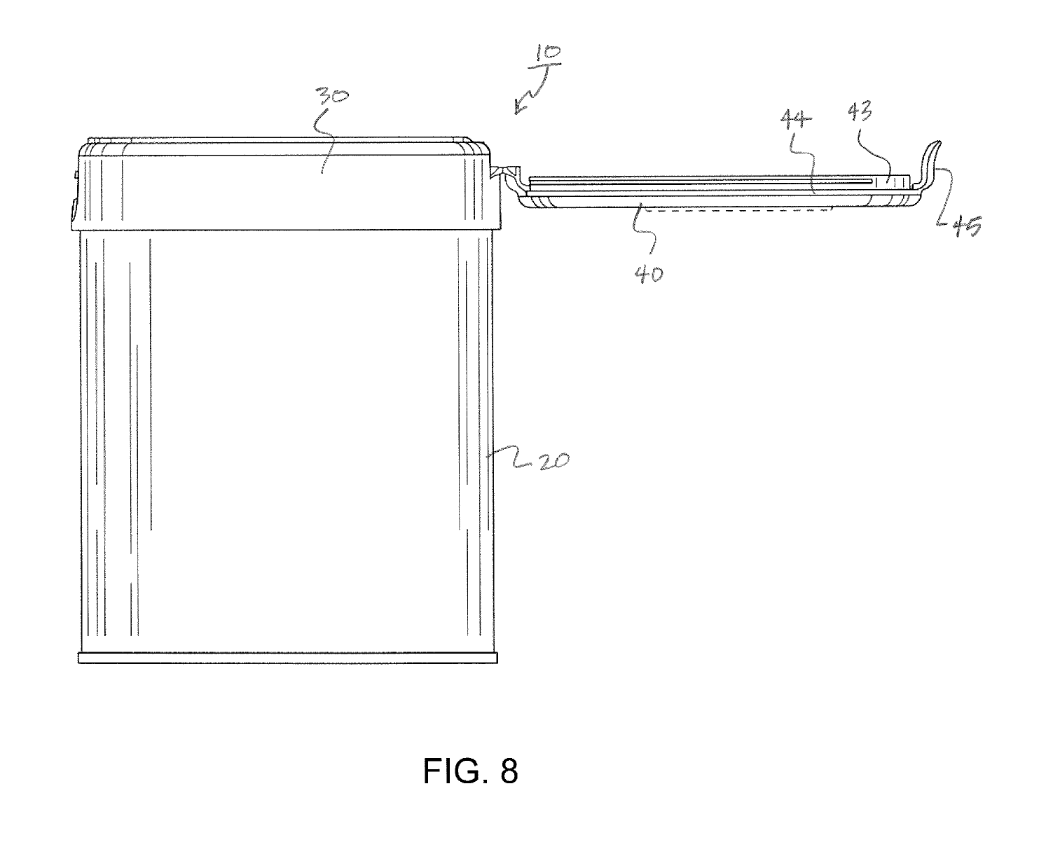

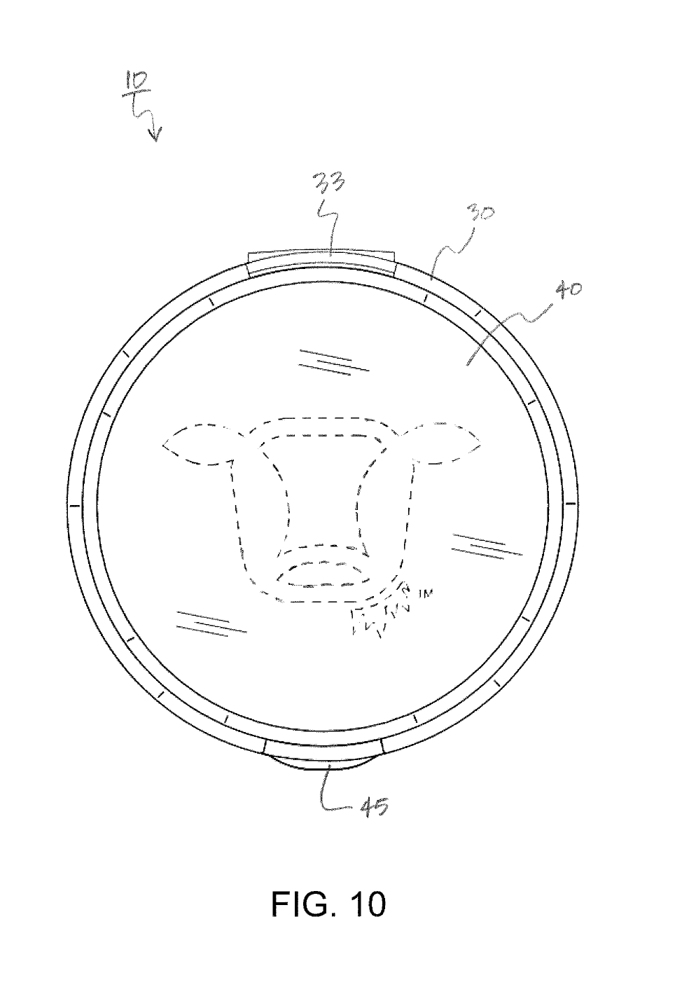

FIGS. 1 and 10 show the lid 40 in a closed position and FIGS. 8-9 and 11-12 show the lid 40 in an open position. The lid 40 is pivotally connected to the collar 30 at a hinge 33. When the lid 40 is open, the contents of the container 20 can be dispensed from within the internal opening 23 of the container 20. When the lid 40 is closed, the lid 40 tightly engages the collar 30 to seal in the contents within the container 20. The lid 40 is shaped to snugly mate with the collar 30 when closed.

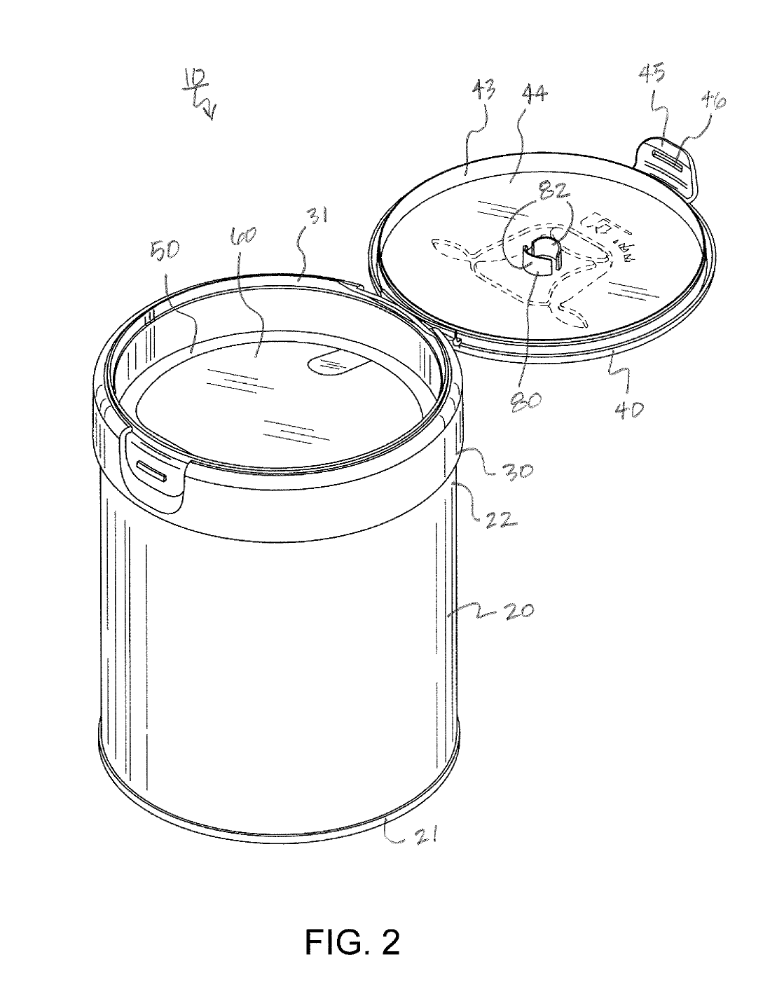

As shown in FIGS. 2 and 7-12, the lid 40 is disk or pancake shaped with a curved upper end 42. The lid 40 is pivotally attached to the collar 30 at the hinge 33. FIG. 8 illustrates a lower skirt 43 extending downward from a lower surface 44 of the lid 40. When the lid 40 is closed over the collar 30, the skirt 43 fits into an opening 31 in the collar 30 in a sleeve type arrangement that allows the skirt 43 to friction fit against the walls of the opening 31. Likewise, a locking tab 45 with a recess 46 disposed on the lid 40 may be snap-locked against a mating protrusion 32 disposed on the collar 30. Various other types of locking arrangements are envisioned within this scope of this subject disclosure.

Various types of tight interference type sealing connections may be provided between the lid 40 and the collar 30. For example, the connection may be a hinged connection, such as a living hinge or otherwise. The lid 40 may be a snap lock lid which may be detachable from the collar 30. Any suitable connection between the lid 40 and the collar 30 according to this subject disclosure is possible.

Referring back, FIG. 2 shows a removable seal 60 attached to the ledge 50 that encircles the internal opening 23. The removable seal 60 and the ledge 50 may be attached to the upper end 22 of the container 20. Alternatively, the seal 60 and the ledge 50 may be integrated into the collar 30.

The purpose of the seal 60 is to create a vacuum seal for the contents in the container 20. The removable seal 60 also acts to serve as an anti-tamper inner liner. Metal processing, adhesive or heat may be used to attach the seal 60 formed of polyvinyl chloride, polystyrene, metal foil, plastic foil or other suitable material to form an airtight seal. The opening of the lid 40 will not disturb the seal 60 unless the seal 60 is cut or removed by the user.

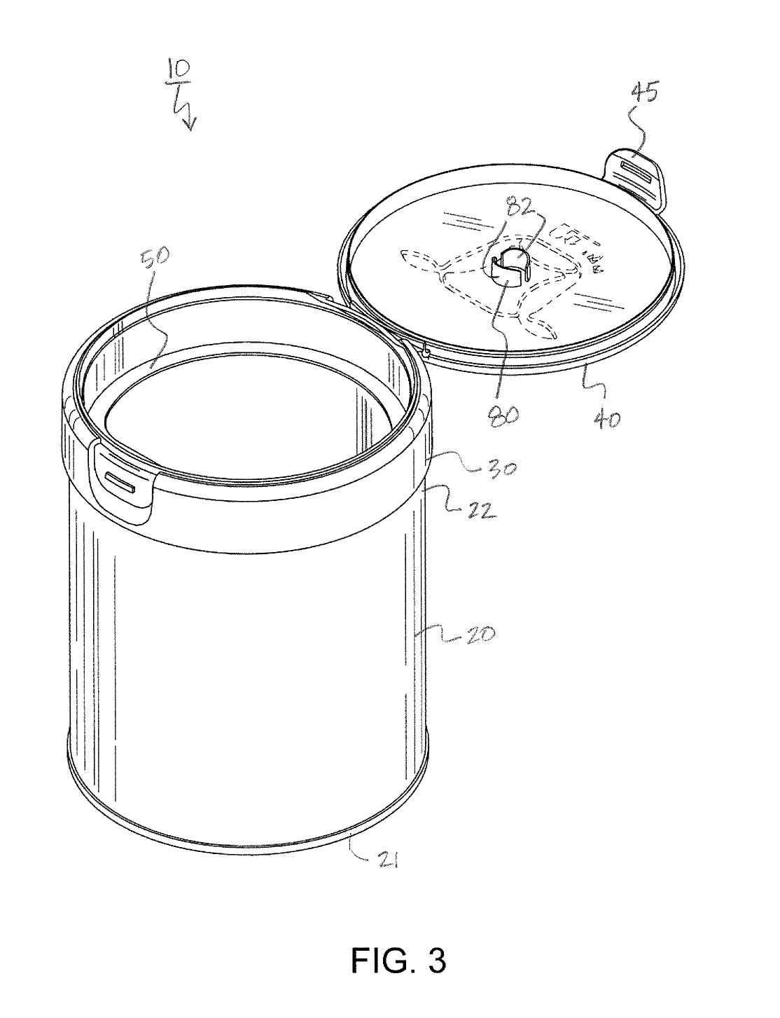

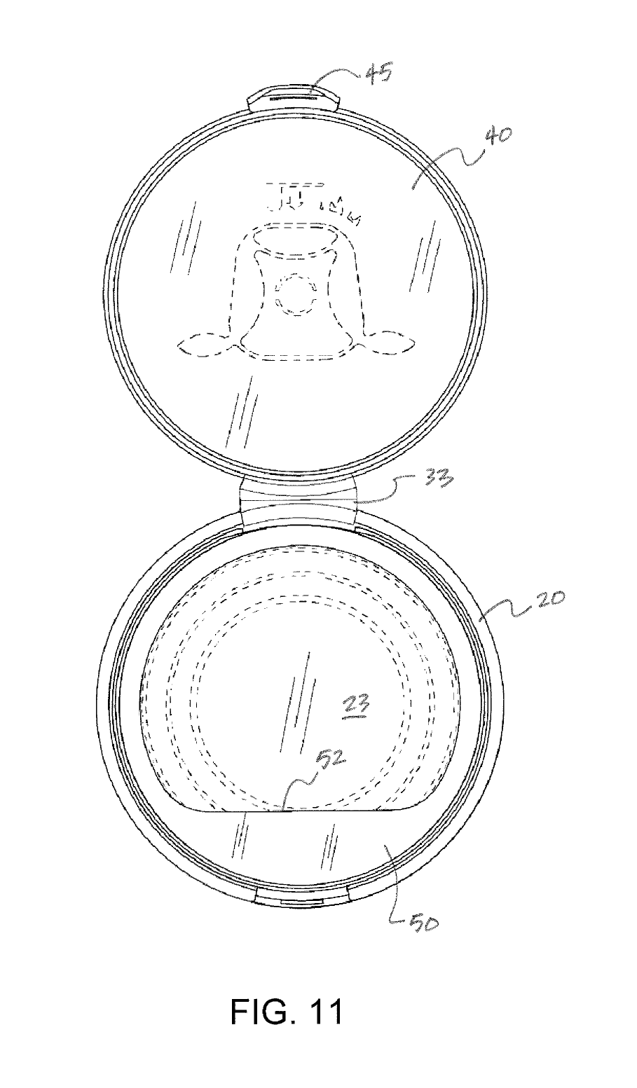

FIGS. 3 and 11 show the ledge 50 constructed to encircle the internal opening 23. At a location along the ledge 50, the ledge 50 has a widened ledge flat portion 52 that partially extends into the internal opening 23. The widened ledge flat portion 52 is configured to allow excess material to be scraped off of the measuring device 70 that is scooped from within the container 20.

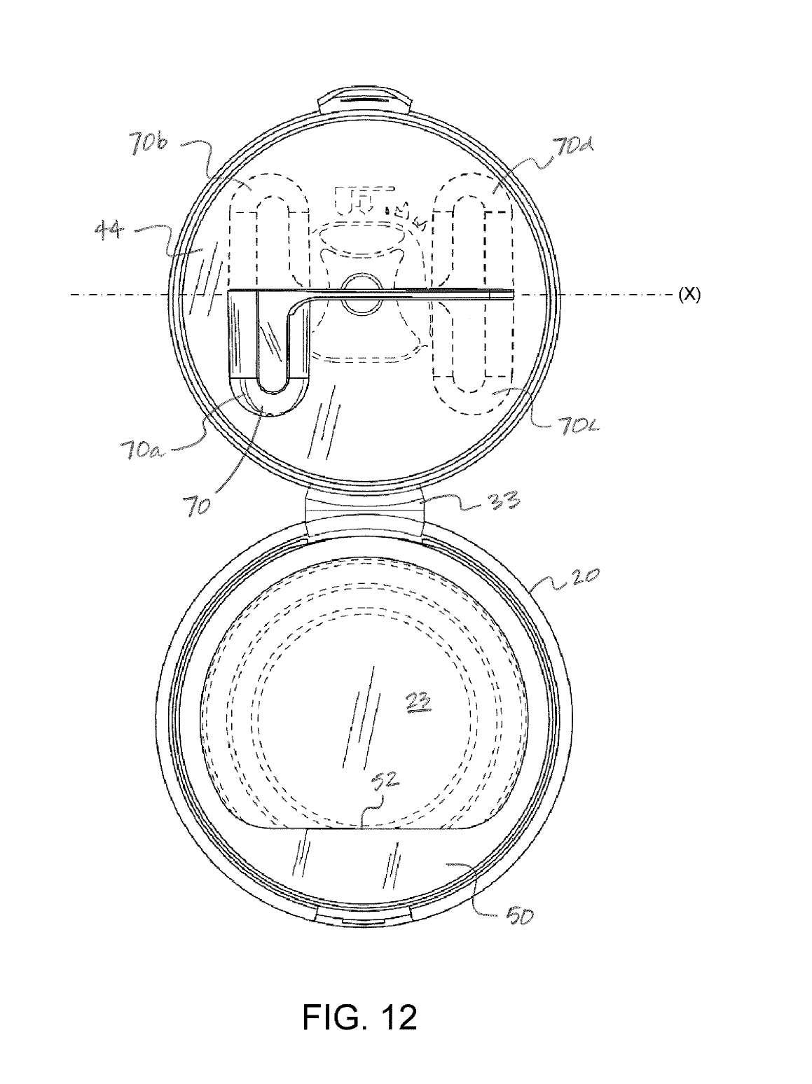

FIGS. 4 and 12 shows an exemplary placement for the measuring device 70. The measuring device 70 may be attached to a fastening mechanism 80 disposed on a lower surface 44 of the lid 40. As shown in FIG. 2, the fastening mechanism 80 is constructed of a pair of crescent shaped projecting ribs, holders or flanges 82 that secure a handle 74 of the measuring device 70 via a friction fit. Alternatively, the handle 74 of the measuring device may also be additionally secured to the flanges 82 by various mating notches provided on the measuring device 70 and the flanges 82 that cooperate to secure the handle 74 of the measuring device 80 to the holders 82.

Another advantage to the crescent shaped projecting flanges 82 is the ability for the measuring device 70 to be stored in a variety of different positions. For example, as shown in FIG. 12, the scoop 72 and the handle 74 of the measuring device 70 lie along an axis (X) in a first right side up position 70a as shown in solid lines. In storage, the scoop 72 and the handle 74 may be stored in a variety of other positions such as shown in hidden lines and labeled 7b, 7c, 7d. That is, the scoop 72 can be flipped, or inverted over the (X) axis facing upside down as shown in phantom lines 7b. Likewise, the scoop 72 and the handle 74 of the measuring device 70 can be reversed 180 degrees along the (X) axis so that the scoop 72 can be positioned facing right side up 70c, or upside down 70d as also shown in the associated phantom line positions.

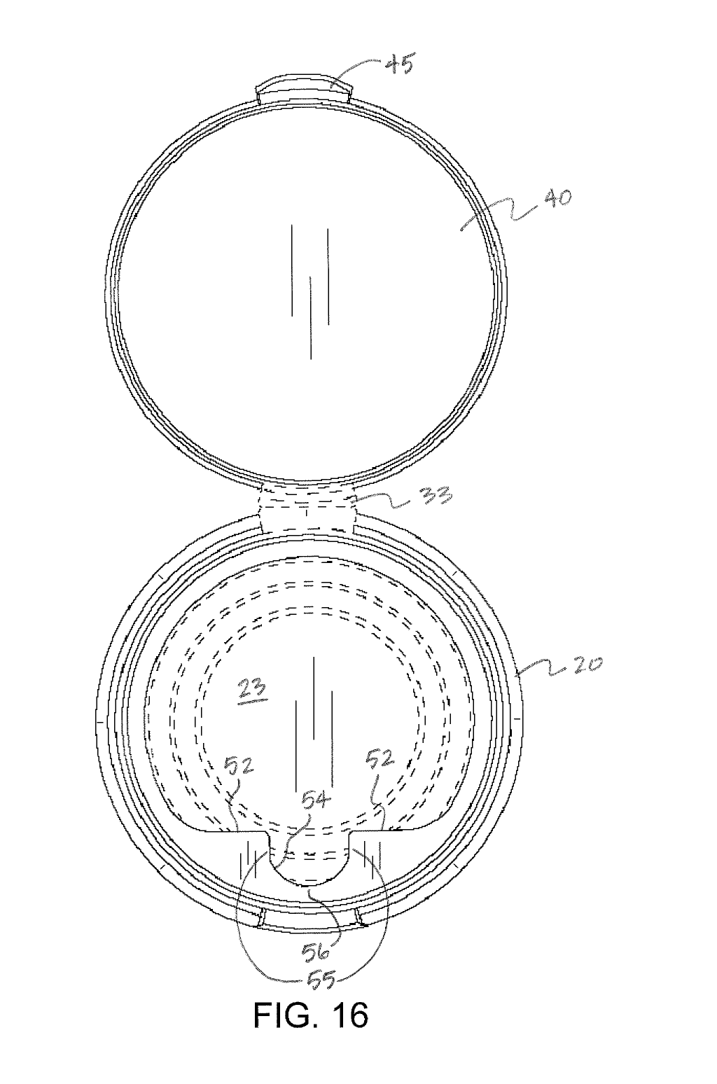

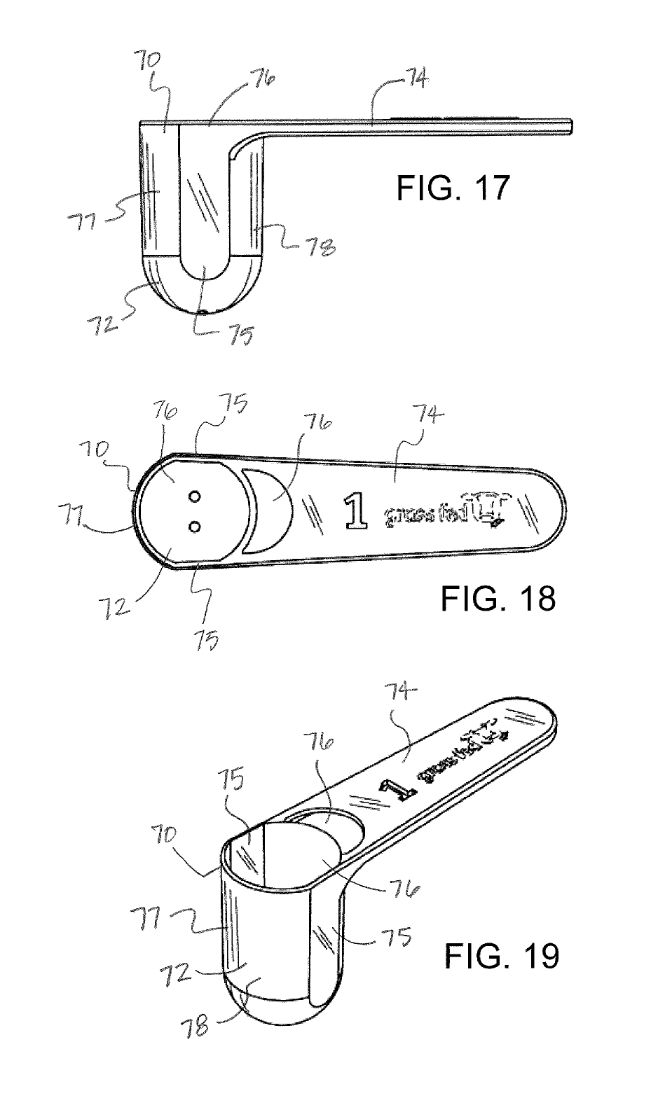

FIGS. 17-20 illustrate various configurations for the measuring device 70. FIG. 17 shows the measuring device 70 having a scoop 72 and a handle 74. The scoop 72 may be configured to have flat sides 75 in order to secure the measuring device 70 securely against a surface it may be butt up against during storage, such as the lower surface 44 of the lid 40 as shown in FIGS. 4 and 12, or within a cut-out 54 within a flat edge 55 of the ledge 50 such as shown in FIGS. 15-16. The measuring device 70 can also have a opening 76 in the handle 74 surrounding the scoop 72 to allow any excess flowable material scooped up to freely fall back into the container 20 through the opening 76.

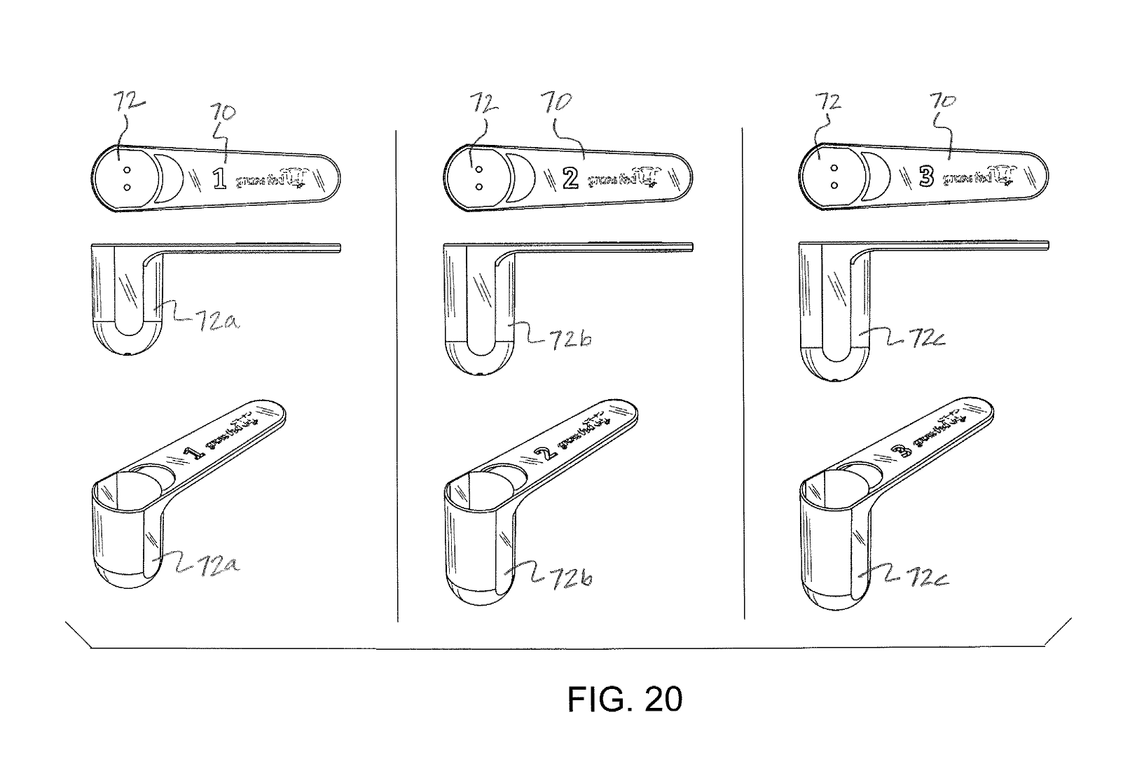

As shown in FIG. 20, various scoop sizes may be adapted for use according to this subject disclosure. For example, a first scoop size 72a (labeled “1”) that is adapted to scoop a first smaller quantity of a flowable material may be used for infants in their first month. A second scoop size 72b (labeled “2”) that is adapted to scoop a second slightly larger quantity of the flowable material may be used for infants in their second month, and a third scoop size 72c (labeled “3”) that is adapted to scoop an even larger quantity of a flowable material may be used for infants in their third, or later month.

The construction of the measuring device 70 can be laid sideways on the flat sides 75 without rolling or turning easily as a result of the flat sides 75 on the scoop 72 portion of the measuring device 70. In another embodiment not shown, it is possible to construct the scoop 72 of the measuring device 70 to substantially match the contour of a lowermost corner edge of the container 20. In this way, the scoop 72 can reach into the container 20 and scrape the corners of the container 20 to more thoroughly withdraw any remaining content in the container 20 from its lower corner edges.

The handle 74 may contain an open area 76 therein to assist in obtaining the correct amount of material within the scoop 72 portion of the measuring device 70. Any excess may fall through the open area. One of ordinary skill in the art would understand that the volume for the scoop 72 may take various volumes depending on the desired measurement of the material to be scooped and collected from inside of the container 20. Likewise, the construction of the handle 74 may take a variety of different sizes and/or shapes as desired.

The measuring device 70 may be molded from a suitable plastic material, which may be blow molded, by extrusion or injection. Suitable plastics for forming the scoop include, may include but are not limited to, various polymers such as polystyrene, polystyrene-acrylonitile, acrylonitile-butadiene-styrene, styrene-maleic anhydride, polycarbonate, high density polyethylene, polyethylene copolymers, polypropylene, polypropylene copolymers, polyethylene terephthalate, polyvinylcyclohexane, and the like, and blends thereof.

Referring back to FIG. 11, the ledge 50 is constructed to securely receive an open end 76 portion of a scoop 72 of the measuring device 70. The flat portion 52 of the ledge 50 may be constructed to match the contour of the open outer edge 73 shape of the open end 76 of the scoop 72 of the measuring device 70. As shown and described here and above, the scoop 72 of the measuring device 70 may contain various flat or contoured edges for a variety of different purposes.

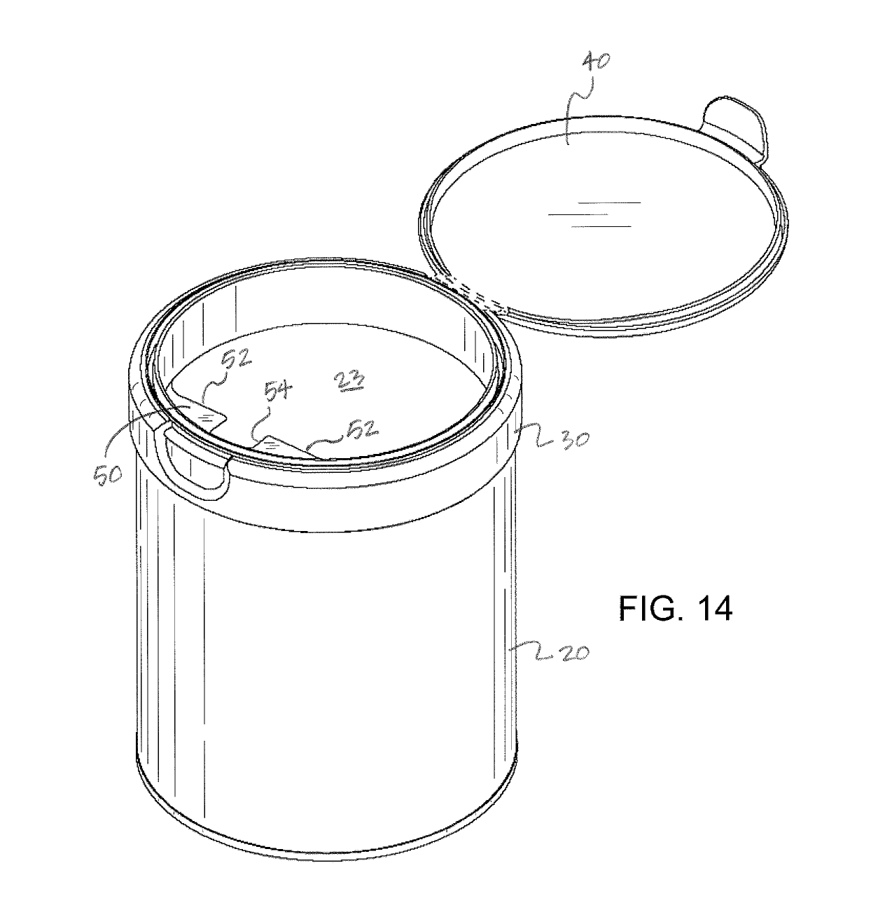

In another exemplary embodiment of this subject disclosure shown in FIGS. 14-16, a cut-out 54 section is provided in the ledge 50 disposed at the upper portion of the container 20. The cut-out 54 section is contoured to substantially mimic all, or portions of the outer shape of the scoop 72. As shown in FIG. 16, the cut-out 54 section has a pair of flat edges 55 that extend into the ledge 50, outward from the flat portion 52 of the scraper 53 toward the body of the container 20. The flat edges 55 are connected by a curved end 56 that mimics all, or some of a curved end 77 of the head 78 of the scoop 72.

The purpose of the cut-out 54 section is to securely store and subsequently locate the measuring device 70 in a convenient location so that the measuring device 70 can be easily found near the top of the container 20 when the lid 40 is lifted to dispense the material from within the container 20 via the measuring device 70. Unlike conventional containers, scoops are oftentimes placed in an unsanitary manner within the flowable material that have the propensity to introduce various harmful contaminants and germs.

Since the measuring device 70 is conveniently located within the cut-out 54 section, rummaging through the flowable material to find the measuring device 70 is unnecessary, and spillage of the contained material and/or contamination of the flowable material may also be prevented.

The ledge 50 serves as a storage mechanism for the measuring device 70 and the flat portion 52 of the ledge 50 serves as a scraping edge to level the contents removed by the scoop 72 of the measuring device 70. The ledge 50 may be incorporated onto the container 20 at approximately the upper end 22 of the container 20. Alternatively, the ledge 50 may be integrated as part of the collar 30 resting above the upper end 22 of the container 20 according to this subject disclosure.

The illustrations and examples provided herein are for explanatory purposes and are not intended to limit the scope of the appended claims. It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

What is claimed:

1. A container assembly comprising:
a container having a closed lower end and an upper open end defining an internal opening therein;
a collar connected to the upper open end of the container; and
a lid connected to the collar, the lid having a holder mechanism for securing a measuring device in various positions thereto.

2. The container recited in claim 1, further comprising a ledge extending partially into the internal opening, the ledge having a flat portion adapted to scrape off excess material scooped from within the container.

3. The container recited in claim 1, wherein the ledge has a cut away section adapted to receive an elongated head portion of the measuring device.

4. The container recited in claim 1, wherein the measuring device has an elongated head portion having at least one flat side on one side to secure the measuring device to the container.

5. The container recited in claim 4, wherein the measuring device is secured to the holder mechanism and the flat side is positioned adjacent to a lower surface of the lid.

6. The container recited in claim 3, wherein the measuring device is secured to the cut away section in the ledge and the flat side of the elongated head portion coincides with a flat edge portion of the cut away section in the ledge.

7. The container recited in claim 1, further comprising a removable seal positioned at the upper open end of the container, and adapted to seal the internal opening.

8. The container recited in claim 1, wherein a handle and an elongated head portion of the measuring device can be located in various positions within the holding mechanism.

9. The container recited in claim 8, wherein the handle and the elongated head portion are aligned along an axis and the various positions comprise:
a right side up position;
an upside down position;
reversed 180 degrees along the axis and in the right side up position; and
reversed 180 degrees along the axis and upside down.

10. A container assembly comprising:
a container having a closed lower end and an upper open end defining an internal opening therein;
a collar connected to the upper open end of the container;
a lid connected to the collar, the lid having a holder mechanism for securing a measuring device in various positions thereto; and
a ledge extending partially into the internal opening, the ledge having a flat portion adapted to scrape off excess material scooped from within the container.

11. The container recited in claim 10, wherein the ledge is constructed as part of the collar.

12. The container recited in claim 10, wherein the ledge is constructed as part of the container.

13. The container recited in claim 10, wherein the ledge has a cut away section adapted to receive a scoop head portion of the measuring device.

14. The container recited in claim 10, further comprising a removable seal fastened to the ledge, and adapted to seal the internal opening.

15. The container recited in claim 10, wherein the holder mechanism comprises a pair of projections defining a slotted opening into which a handle of the measuring device is secured.

16. The container recited in claim 10, wherein the handle and an elongated head portion are aligned along an axis and the various positions comprise:
a right side up position;
an upside down position;
reversed 180 degrees along the axis and in the right side up position; and
reversed 180 degrees along the axis and in the upside down.

17. A container assembly comprising:
a container having a closed lower end and an upper open end defining an internal opening therein;
a collar connected to the upper open end of the container;
a lid connected to the collar, the lid having a holder mechanism comprising a pair of projections defining a slotted opening;
a measuring device having a handle and a scoop, the handle being removably secured to the slotted opening in the holder mechanism; and
a ledge extending partially into the internal opening, the ledge has a flat portion adapted to scrape off excess material scooped from within the container.

18. The container recited in claim 17, wherein the ledge has a cut away section adapted to securely receive an elongated head portion of the scoop.

19. The container recited in claim 17, further comprising a removable seal positioned at the upper open end of the container, and adapted to seal the internal opening.

20. The container recited in claim 17, wherein the handle and the scoop are aligned along an axis and the various positions comprise:
a right side up position;
an upside down position;
reversed 180 degrees along the axis and in the right side up position; and
reversed 180 degrees along the axis and in the upside down position.
